(19) United States
(12) Patent Application Publication
(10) Pub. No.: US 2011/0040400 A1
(43) Pub. Date: Feb. 17, 2011

(54) FEEDSTUFF FORMULATIONS

(75) Inventor: Bo Buchmann, Frederiksberg (DK)

Correspondence Address: HARNESS, DICKEY & PIERCE, P.L.C., P.O. BOX 8910, RESTON, VA, 20195, US

(73) Assignee: Foss Analytical A/S, Hilleroed (DK)

(21) Appl. No.: 12/736,623

(22) PCT Filed: Apr. 16, 2009
(86) PCT No.: PCT/EP2009/054522

§ 371 Date: Oct. 22, 2010

(30) Foreign Application Priority Data
May 7, 2008 (EP) PCT/EP2008/055601

(51) Int. Cl. G06F 17/00; G06Q 10/00

(52) U.S. Cl. 700/103; 705/7

(57) ABSTRACT

A method of formulating a feedstuff is provided which comprises the steps of: analysing the effect on one or both chemical and biological properties of the feedstuff of varying feedstuff ingredients and analysing the effect on the ingredient cost of the feedstuff of varying the feedstuff ingredients. The method further comprises a step of analysing the effect on a predicted production cost of the feedstuff of varying the feedstuff ingredients and a step of determining a desired formulation of a feedstuff for production on the basis of at least the analysed effects on the properties, on the ingredient cost and on the predicted production cost of varying the feedstuff ingredients.

The present invention relates to the production of animal or fish feedstuff, including pet-food, and in particular to the optimisation of the production of compound feedstuff formulations based on a cost consideration.

Compound feedstuff today is a mix of several ingredients. Animal feedstuff for example, typically comprises one or more base ingredients, such as soya-beans, corn or other cereal grain, that together make up the bulk of the feedstuff and which are complemented with minerals, vitamins and other dietary supplements. The exact feedstuff formulation is intended to provide a desired effect on animal welfare and/or output upon consumption. This is in large determined by the chemical (such as levels of nutrients and other chemical components) and/or biological (such as digestibility and nutrient conversion) properties of the ingredients.

It is well known to establish a feedstuff formulation based on the chemical and/or biological properties of the ingredients; the known cost of the individual ingredients; and the desired effect of the final formulation upon consumption. The desired effect may often be expressed in terms of desired chemical and/or biological properties of the feedstuff formulation which are necessary to achieve the effect.

In this manner a feedstuff formulation can be established which provides a desired effect with an optimised ingredient cost. This is commonly known as Least Cost Optimisation (‘LCO’) or Least Cost Formulation but shall be referred to hereinafter as LCO. This is a method of determining the least-cost combination of ingredients using a series of mathematical equations.

LCO software solutions also exist that operate to automate the establishment of feedstuff formulations according to this methodology. Typically these solutions operate to mathematically analyse the effects of varying types and proportions of feedstuff ingredients of known cost on chemical and/or biological properties of a feedstuff formulation. From this analysis a feedstuff formulation is established that meets the desired chemical and/or biological properties (that is to say, achieves the desired effect) at a least ingredient cost for the producer. Other considerations such as palatability of the formulated feedstuff and ingredient availability may also be employed in the LCO solutions in order to establish limitations on acceptable ingredient combinations when establishing the feedstuff formulation using the LCO methodology.

These existing software solutions and methodology optimise the ingredient cost very well but ignore other costs which contribute in a smaller but still significant manner to the overall cost of the optimised feedstuff.

What has not been addressed to-date in known LCO methods and what is addressed by the current invention is that the production cost can vary significantly with different feedstuff formulations.

According to the present invention there is provided a method of, a software solution and a system for formulating feedstuff, each of which incorporates a same and improved LCO methodology. By additionally analysing the effects the feedstuff ingredients on an expected production cost for the formulation then a formulation may be achieved that is optimised not only in terms of the actual, known material cost but also in terms of a predicted production cost.

Preferably the analysis is performed through the application of a prediction model to input information regarding ingredients of a proposed feedstuff formulation. The prediction model establishes a mathematical relationship between information regarding feedstuff formulation and a value indicative of a production cost of the formulation and operates to predict an indication of a production cost from information regarding a proposed formulation. The model is generated from information and actual production cost indications related to known formulations. Such information may include information regarding the one or both the amounts and chemical and/or physical properties of the ingredients and may comprise spectral data, including nuclear magnetic resonance (NMR) spectral data but particularly infrared and more particularly near infrared (NIR) spectral data, indicative of these properties. Such a model may usefully also be made dependent on process information relating to the manufacturing conditions of the proposed formulation.

The analysis of the effects of a proposed formulation on predicted production cost may usefully involve a prediction of those process parameters which may be employed in the control of the production process to produce the proposed formulation at an optimised (lower) production cost. This aspect is particularly useful in the production of feedstuff formulations where there is a limited available variation in formulation parameters, for example in the case of fish feedstuff where typically the number of available ingredients is limited.

The analysis of the effects on production cost may alternatively or additionally involve the prediction of the effect of varying the ingredients on those physical properties of a proposed formulation which influence the efficiency of the production process. For example, during production the largest bottleneck is typically at the pellet pressing stage where a press, such as a roller press, forces the mixed feed through a large die in order to produce the pelletized feedstuff that is provided for consumption. It is here that the physical characteristics of the feed mix, such as potential for gelatinization; brittleness; and adhesiveness, has the greatest impact and it is here where the potential for production cost saving is greatest.

Wastage, for example during manufacture and storage at a production facility, during transportation and during storage and handling at a farm, is also a factor that contributes to the overall production cost of the final formulation. One important indication of the potential wastage is the durability of the final feedstuff which is determined by physical properties of that feedstuff. Durability reflects how well the pellets will resist physical abrasion. This abrasion generally results in the production of fines which in the production process may have to be removed from the pelletized feedstuff for recycling and which on-farm tend to remain uneaten.

In the production process the presence of fines increases the total cost of production for the manufacturer whilst on-farm the presence of fines leads to a lowering of the feed conversion (which may be expressed as desired effect per kilo of feedstuff provided for consumption) and thus an increase in production cost for the farmer. Usefully the analysis of the effects on production cost includes predicting wastage, for example by establishing an indication of the physical durability, which may then be used to establish the LCO formulation according to the present invention.

Indeed requirements on physical properties of the feedstuff may be employed as an input to the LCO method according to the present invention in which they are used to establish further limitations on acceptable ingredient combinations of feedstuff formulations that may be determined in accordance with the method of the present invention.

Preferably the method according to the present invention is realised in program code, typically on a computer readable storage medium or other carrier, which is executable by a computer to control the computer to perform some or all of the steps of the method and to generate an output indicative of the determined desired LCO formulation. Advantageously, the computer may form part of a, typically fully or partially automated, system for the production of feedstuff which system also comprises a feedstuff production facility responsive to the output to selectively combine the ingredients of the feedstuff to produce the desired formulation.

These and further advantages will be understood by a consideration of the following description of preferred embodiments of the invention which is made with reference to the drawings of the accompanying figures, of which:

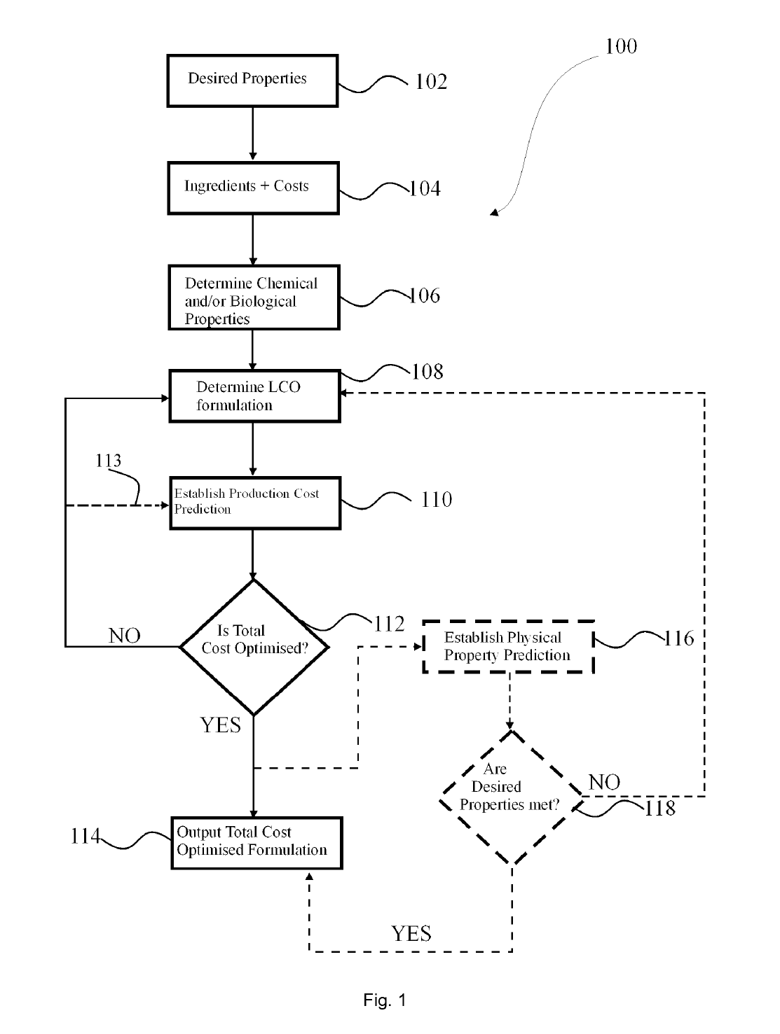

FIG. 1 illustrates an embodiment of the method according to the present invention;

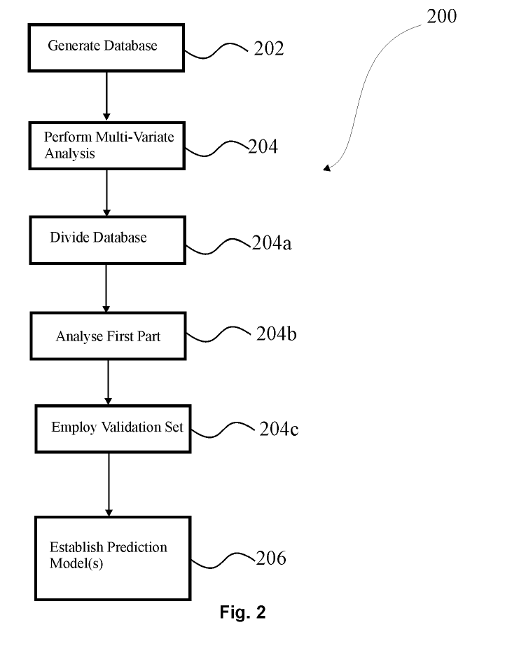

FIG. 2 illustrates a method of establish a prediction model that may be employed in the method of FIG. 1; and

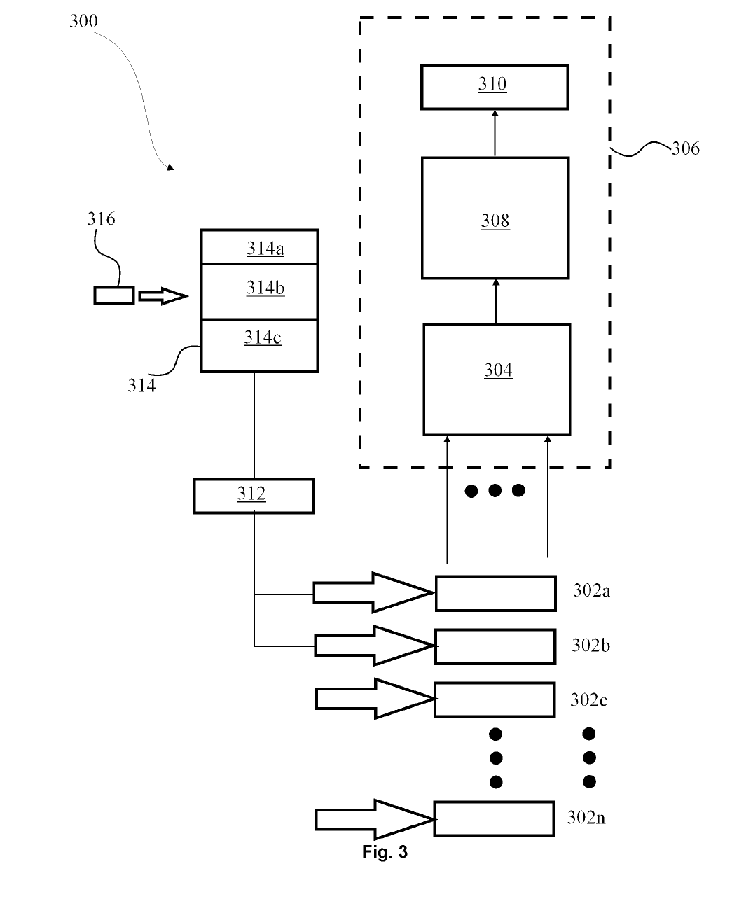

FIG. 3 illustrates a feedstuff production system according to the present invention.

Considering now FIG. 1 in which is illustrated a flow chart 100 of exemplary steps for producing a feedstuff formulation according to the method of the present invention. Steps 102 to 108 are those commonly employed in known LCO methods and so will be discussed in outline only.

At step 102 a desired effect of a feedstuff to be produced is established. This desired effect may be represented by desired properties, particularly chemical and/or biological properties, and in the present embodiment comprise chemical properties which may be represented by range limits for desired nutrient levels, such as for protein, fat, amino acid and vitamins. Such properties could usefully also include range limits for amounts of starting ingredients that may be present in the final feedstuff formulation. This range typically will depend on one or more of the availability of starting ingredients and biological properties such as the palatability of the final product and the uptake and conversion of the nutrients on consumption.

According to an embodiment of the present invention desired physical properties of the formulated feedstuff may also be included at this step 102 where they may be employed to establish range limits for the amounts of ingredients that may be combined into a feedstuff or may be used as an indication of production cost of a formulation.

It will be appreciated that one or more of the desired properties may vary dependent on the desired effect of the feedstuff when consumed. For example one set of desired properties may be used to produce a feedstuff for a cow that has as a desired effect the increased milk production whereas another set of desired properties may be used to produce a feedstuff for fish that has as a desired effect increased weight gain or for hens an increased egg production. It will be further appreciated that the desired properties of a feedstuff may be selected so as to provide more than one desired effect upon consumption.

At step 104 the available ingredients, any feed supplement and the known costs of both are received.

At step 106 at least one chemical and/or biological property of one or more of the available ingredients is established. For feed supplements and other manufactured additives at least chemical properties are typically readily available from the manufacturer and so may be obtained directly. For other ingredients, such as the above mentioned base ingredients, the chemical and/or biological properties tend to vary from batch to batch and so the one or more properties of each of these ingredients is typically measured on-site, either just before use or as a new batch is received. Today such measurements are often made using infrared spectroscopy, particularly near infrared (NIR) spectroscopy, but any one or more known analysis techniques may be employed. According to the present exemplary embodiment infrared spectral data is generated which is characteristic of the batch of ingredient and a prediction model of known type is employed on the data to predict from that data the information on the chemical and/or biological properties of that ingredient.

Such a prediction model is established using known chemometrical techniques which employ either linear or non-linear multivariate statistical analysis, for example Partial Least Squares (PLS); Principle Component Analysis (PCA); Multiple Linear Regression (MLR); or Artificial Neural Network (ANN), to generate a mathematical relationship by which the infrared spectral data of the one or more ingredients is correlated with the properties of interest.

At step 108 a feedstuff formulation is determined by LCO which, in a known manner, provides a formulation that achieves the desired effect (or effects) with reference to desired chemical and/or biological properties at least ingredient cost.

At step 110 an indication of a predicted production cost for the formulation determined by LCO at step 108 is established using a prediction model which provides a mathematical relationship between properties of some or all of the ingredients, in the present embodiment as reflected in infrared spectral data generated at block 106, and an indication of a production cost of that formulation. The construction of this prediction model is discussed in more detail below with reference to FIG. 2.

At step 112 a decision is made as to whether the total cost of the feedstuff is optimised, taking into account the known ingredient costs (according to LCO at step 108) and the predicted cost of production (established at step 110).

If not then a new formulation is determined by LCO at step 108 and an indication of its production cost generated at step 110. This iteration may be repeated until the total cost of the feedstuff formulation is optimised.

In an alternative embodiment of the present invention one or more process parameters are associated with the cost of production as predicted at step 110 and are generated as an indication of the predicted production cost. In one embodiment if, at step 112 a decision is made which indicates that the total cost is not optimised then a new set of process parameters is generated at step 110 [illustrated in FIG. 1 by the broken arrow 113]. In a further embodiment of the present invention these process parameters are generated in addition to the generation of a new formulation at step 108. In this instance if a decision is made that the cost is not optimised then a new formulation is generated at step 108.

When a total cost of the feedstuff has been optimised then, at step 114 an output of the determined feedstuff formulation is generated for subsequent use in the manufacture of the feedstuff. In certain embodiments this may be provided in addition or as an alternative to those process parameters determined as being cost-wise optimal for the production of a particular formulation.

In a further embodiment according to the present invention physical properties of the proposed feedstuff formulation are also predicted. In the present exemplary embodiment of FIG. 1 when a total cost optimisation is achieved at step 112 then additionally the physical properties of the proposed feedstuff formulation are predicted at step 116. These are compared with desired physical properties which were input at step 102 and a decision is made at step 118 as to whether the predicted properties fall with the range established for the desired properties. If not then a new LCO formulation is determined at step 108 and the iteration is repeated until all desired properties are met at an optimised total cost. At this time an output of the optimised feedstuff formulation according to the present invention is made at step 114.

It will be appreciated that the order or presence of at least some of the steps of the method according to FIG. 1 may be varied without departing from the invention as claimed.

A method for constructing a prediction model for establishing an indication of production cost which is used at step 110 of FIG. 1 is illustrated in the flowchart 200 of FIG. 2.

In the present embodiment the prediction model is established using known chemometrical techniques which employ either linear or non-linear multivariate analysis to generate a mathematical relationship by which the data from one or more of the ingredients is correlated with a value indicative of a predicted production cost. In the present embodiment infrared, particularly NIR, spectral data is employed. This has an advantage that the same data may be used in predicting the indication of the production cost as that which is collected in order to predict chemical/biological and/or physical properties of ingredients at step 106 for use in determining an LCO formulation at step 108 of the method according to FIG. 1. Such infrared spectral data is, in the present embodiment, collected using known techniques such as transmission, reflection, reflectance, Fourier Transform or Raman Scattering techniques

However, data may be obtained at other wavelength regions of the electromagnetic spectrum, including visible and X-ray wavelength regions, or may be obtained by other analytical techniques, including NMR and image analysis techniques, provided always that such data is influenced by the properties of the ingredients that are determinative of production costs and, optionally physical properties, of the proposed feedstuff formulation. The existence of such an influence may be verified through reasonable trial and error using the aforementioned known multivariate analysis techniques on the data in question in order to determine a degree of correlation between the data and the production costs.

A first step 202 in establishing such a prediction model is the generation of a database (or information matrix) wherein each record represents a production lot. In this database is stored spectral information, typically infrared and preferably NIR spectral information, from known production lots and can include spectra from one or both the individual ingredients or from the final feedstuff. The database also includes information identifying the classes of ingredients included in that production lot; actual proportions (for example by weight) of ingredients included in that production lot and process settings (both fixed and variable) employed in the production lot. Also included in the database and indexed against this other information is a value indicative of a known production cost associated with the actual production lot. This value may be represented by one or more of an actual production cost, production speed, production energy consumption, production wastage, production stoppage and measurable physical parameters of the feedstuff that may influence any or all of the previous production process parameters.

Physical characteristic will also necessarily be required as input in the embodiment where such physical characteristics are to be employed as desired properties of a feedstuff formulation for production which is established at step 114 of the method according to the present invention which is illustrated at FIG. 1. Moreover, process control parameters associated with known production costs of actual production lots may additionally or alternatively be required as input to the database at step 202. Such data will be required where the output at step 114 of the method illustrated at FIG. 1 includes the generation of analogous process control parameters that are cost-wise optimised for a particular formulation.

At step 204 the contents of the database is subjected to a multivariate statistical analysis. In the present example this comprises the step 204a of dividing the database from step 202 into two parts. The first and largest part is subjected to the multivariate analysis at step 204b. The second part is employed at step 204c as an independent validation set. It will be appreciated that the precise usage and division of the content of the database will depend on the particular analysis technique employed in establishing the prediction model.

At step 206 a prediction model is established by which is provided a mathematical relationship between input information related to a particular feedstuff formulation and its production cost and is for use in predicting an indication of a production cost for a proposed feedstuff formulation. This indication may be a direct currency value to be added to the ingredient cost or may be an indicator of a level of additional cost or may include process parameters for use in controlling a production process to provide a particular formulation at optimum cost. As an alternative, a separate prediction model may be generated to predict each of one or more quantifiable components (for example actual production cost, speed, energy consumption, wastage or stoppage) of the production cost.

Additionally or alternatively spectral information may be generated both before and after the one or more of the available ingredients are subjected to conditions, most usefully, heat-stress conditions, which mimic actual conditions experienced during the manufacturing process. Thus, for example, additional spectra may be acquired after subjecting one or more of the ingredients to heat-stress and subsequent cooling. These additional spectra for each production lot are then stored in the database that is established at step 202. By subjecting the ingredients to such mimicking conditions then the prediction model or models generated at step 206 may more accurately predict the production cost for manufacturing a specific feedstuff formulation, particularly in circumstances where such stress conditions produces a hysteresis effect on the obtained spectral information.

In use the information, here spectral data, regarding individual ingredients of a proposed feedstuff formulation determined at step 108, as well as information on the process set-up to be used in its manufacture, is processed using the prediction model according to the present invention to generate an indication of a predicted production cost of manufacturing that particular feedstuff formulation, possibly as process control parameters for use in controlling a manufacturing process for that particular feedstuff formulation.

It will be appreciated that the prediction model according to the present invention may be established using additionally or alternatively other data such as information regarding amounts (or proportions) of ingredients in a production lot and employed to predict a production cost based on the input into the model of the same information from a proposed formulation. It will also be appreciated that the information from a production lot may be pre-processed in a manner known in the art in order to compress the spectral data into fewer data-points and to eliminate interfering spectral phenomena such as light-scattering before being used to establish the prediction model.

Considering now a feedstuff production system 300 according to the present invention that is illustrated in FIG. 3. Storage bins 302a . . . 302n are provided for containing the different ingredients which are available to be processed into a formulated feedstuff and may include bins for storage of bulk material, such as base ingredients; tanks for liquid ingredients and so-called ‘micro-silo’ bins for the storage of high cost powdered ingredients, such as feed supplements. Each bin 302a . . . 302n is, in the present embodiment, connected to a mixing device 304 of a feedstuff production facility 306 via individually controllable material transport systems (not shown), such as augers and one or more associated weighing troughs for the transport and weighing of bulk ingredients and such as micro-silo dosage systems for the transport and dosing of the powdered supplements. The mixing device 304 of the present embodiment also operates to automatically control the transport systems in order to establish a compound feedstuff mix having desired ingredients.

Also included in the production facility 306 of the present example are pellet press 308 and feedstuff storage bin 310. After mixing in the mixing device 304 the formulated feedstuff is passed to the pellet press 308 where it is physically formed into its final state for delivery to a customer. In a typical livestock production facility the press 308 may comprise a known die and press arrangement by which feedstuff is pressed through holes in the die to break into smaller pellets under its own weight. These pellets are then placed in the storage bin 310 from where it is transported to the customer.

An analyser 312 is also provided as a part of the system 300 to analyse some or all of the ingredients (here illustrated as available for the analysis of two ingredients) as they are delivered to their respective bins 302a . . . 302n to determine chemical and/or biological properties of interest. The analyser 312 may include a spectral analyser, typically an infrared spectral analyser, particularly an NIR spectral analyser, which obtains a characteristic spectrum for the ingredient being analysed for use in the determination of the chemical and/or biological properties of interest. The same or different analyser 312 may also make analysis of ingredients before and after subjecting the respective ingredient to heat-stress and subsequent cooling and provide the spectral data as an output.

A computer 314, which may be a networked computer system and which may reside at a site physically remote of the production facility 306, is also provided and which generally comprises a user interface portion 314a; a memory portion 314b and a data input/output (I/O) portion 314c.

The computer receives as input information regarding the chemical properties of the available ingredients, partially via the I/O 314c as spectral information output from the analyser 312 and partially via the user interface 314a as input from a user. Other information relevant to the determination of an LCO feedstuff formulation, such as desired characteristics of the feedstuff, may also be input by the user via the user interface 314c or may be received electronically via the I/O 314c from another device or may be stored in the memory 314b.

According to the present embodiment the computer 314 is also adapted to receive instructions via a removable computer readable storage medium 316, such as an optical disk or a memory stick. This storage medium 316 carries an executable program code portion which when run causes the computer to execute a method for formulating a feedstuff according to the embodiment of FIG. 1 and to generate an output via the I/O 314c to control the operation of the mixing device 304 to generate and mix the formulation established according to the above mentioned methodology by which is provided a cost optimised formulation based not only on ingredient costs but also on production costs.

It will be appreciated that the feedstuff production facility 306 of such a feedstuff production systems 300 will vary in complexity depending on, for example, the nature and the amount of feedstuff to be produced. Additional components such as grinders, to grind ingredients before mixing; spraying and coating systems for the addition of liquids; heaters, in which steam is added to the mixed feedstuff formulation in order to raise its temperature; and coolers, in which the pelletized feedstuff is then cooled before being sent to the storage bin 310, may even be present in the system illustrated in FIG. 3 and contribute to, for example, the energy consumption of the production process and so the production cost of the feedstuff. Such variations are intended to be included with the scope of the invention as claimed.

Moreover, further analysis, typically NIR spectral analysis, performed on the intermediate products during the feedstuff manufacture may be used to control the manufacturing process.

1. A method of formulating a feedstuff comprising the steps of: analysing the effect on one or both chemical and biological properties of the feedstuff of varying feedstuff ingredients; and analysing the effect on the ingredient cost of the feedstuff of varying the feedstuff ingredients; characterised in that the method further comprises a step of establishing an indication of a predicted production cost dependent on the feedstuff ingredients and a step of determining a desired formulation of a feedstuff for production on the basis of at least the analysed effects on the properties and on the ingredient cost of varying the feedstuff ingredients and on the indication of the predicted production cost.

2. A method as claimed in claim 1 characterised in that establishing the indication of a predicted production cost of the feedstuff comprises a step of inputting information concerning the ingredients into a prediction model by which is provided a relationship between the input information and a production cost and a step of processing the input information using the prediction model to establish an indication of the predicted production cost as an output.

3. A method as claimed in claim 2 characterised in that inputting the information comprises inputting information related to spectral data obtained from at least one of the ingredients.

4. A method as claimed in claim 3 characterised in that inputting information related to spectral data consist of inputting information related to infrared spectral data.

5. A method as claimed in claim 3 or claim 4 characterised in that the spectral data represents spectral measurements made at least before and after subjecting the ingredient to heat-stress.

6. A method as claimed in claim 2 characterised in that inputting the information comprises inputting information related to image data obtained from at least one of the ingredients.

7. A method as claimed in claim 2 characterised in that inputting the information comprises inputting information related to NMR data obtained from at least one of the ingredients.

8. A method as claimed in any preceding claim characterised in that establishing the indication of a predicted production cost of the feedstuff comprises establishing a prediction indicating one or more of actual production cost; production speed; production energy consumption; production wastage and production stoppage.

9. A method as claimed in any preceding claim characterised in that establishing the indication of a predicted production cost of the feedstuff comprises establishing a prediction indicating one or more process control parameters for implementation in a production process for the feedstuff by which parameters production cost is optimised.

10. A method as claimed in any of the preceding claims characterised in that there is provided a step of predicting an indication of one or more physical properties of the feedstuff dependent on feedstuff ingredients and in that the step of determining a desired formulation of a feedstuff for production is made also on the basis of the predicted indication of the one or more physical properties.

11. A method as claimed in claim 10 characterised in that establishing the indication of the predicted production cost is dependent on the predicted indication of one or more physical properties of the feedstuff.

12. A computer program comprising program code means executable by a computer for controlling the computer to perform or control the steps of the method according to any one of the preceding claims.

13. A computer readable storage medium (316) carrying a computer program according to claim 12.

14. A method of manufacturing a feedstuff comprising the step of formulating a feedstuff to be manufactured according to the method of any one of the claims 1 to 11.

15. A system for the production of feedstuff comprising: a computer (314); a computer program as claimed in claim 12 and executable by the computer (314), the computer (314) being further adapted to output a representation of one or both a desired formulation for production and process control parameters for control of a production process for a desired formulation; and a feedstuff production facility (306) responsive to the output to one or both selectively combine the ingredients of the feedstuff and to operate according to the process control parameters to produce the desired formulation.
